(19) United States
(12) Patent Application Publication
(10) Pub. No.: US 2011/0205836 A1
(43) Pub. Date: Aug. 25, 2011

(54) DEVICE FOR HOMOGENIZING A GLASS MELT

(76) Inventors: Frank-Thomas Lentes, Bingen (DE); Karin Naumann, Ober-Olm (DE); Christoph Berndhaeuser, Nieder-Olm (DE); Erhard Zemsch, Mitterteich (DE); Volker Trinks, Mitterteich (DE)

(21) Appl. No.: 13/034,114

(22) Filed: Feb. 24, 2011

(30) Foreign Application Priority Data
Feb. 25, 2010 (DE) 10 2010 000 546.0

(51) Int. Cl. B01F 7/00

(52) U.S. Cl. 366/325.92

(57) ABSTRACT

The device for homogenizing a glass melt has at least one stirring device, which includes a rotatable stirrer shaft (10) and stirrer paddles (11, 11′, 11″). The stirrer paddles are arranged at intervals from each other along the stirrer shaft to produce an essentially axially oriented conveying effect on the glass melt. To improve homogenization while simultaneously saving on noble metal material, the stirrer paddles (11, 11′, 11″) are each provided with a built-in element (11E). The built-in element (11E) has an edge (11K), which extends from the stirrer shaft (10) in a radial direction (R) along a rear paddle area (11B) with an edge length which is less by a specified distance (X) than the length (L) of the paddle area (11B) in a radial direction (R). These built-in elements provide a marked reduction in bubble formation.

### CROSS-REFERENCE

The subject matter described and claimed herein below is also described in German Patent Application No. 10 2010 000 546.0, filed on Feb. 25, 2010 in Germany. This German Patent Application provides the basis for a claim of priority of invention for the invention described and claimed herein below under 35 U.S.C. 119 (a)-(d).

### BACKGROUND OF THE INVENTION

1. The Field of the Invention

This invention relates to the homogenization of a glass melt, particularly the homogenization of a glass melt, which is used to manufacture a glass or glass ceramic product of high quality and with a low density of inclusions and/or defects, for example display glass or glass tubes.

2. The Description of the Related Art

The purpose of homogenizing a glass melt is to reduce spatial and temporal fluctuations in the chemical composition of the glass melt according to the product specifications. Chemical inhomogeneities lead to inhomogeneities in the refractive index, which can impair for example the optical image, and to inhomogeneities in viscosity, which can lead to uncontrolled geometrical fluctuations during hot forming processes. Here, a distinction is made between a macro-inhomogeneity, which is a variation in chemical composition on a relatively large spatial scale, for example of a few centimetres, with a small spatial gradient, and a micro-inhomogeneity (also known as a stria), which is a variation in the chemical composition on a relatively small spatial scale, for example of 0.1 to 2 mm, with in part a large spatial gradient. The aim of the homogenization process is to remove as far as possible the macro-inhomogeneities and the micro-inhomogeneities, so that a uniform refractive index gradient can be obtained. Usually, the glass melts used have a viscosity between about 1 and 200 Pa·s (10-2000 Poise) which produces a laminar flow of the glass melt (Reynolds number<1). The chemical diffusion coefficient is normally less than 10-12 m²/s so that the homogenization attainable by diffusion is negligibly small. For this reason, homogenization in glass melts can essentially only be achieved by vigorously stretching, redistributing and chopping local inhomogeneities and striae. Stirring systems are used for this purpose having a mixing vessel or a melt container for temporarily receiving the glass melt and at least one stirring device for stirring the glass melt.

DE 10 2007 035 203 A1 describes a device for homogenizing a glass melt with at least one stirring device which is arranged in a mixing vessel that contains the glass melt and has an inlet and an outlet. The stirring device has a stirrer shaft rotatable in a direction of rotation and a plurality of stirrer paddles that are arranged at intervals to each other along the stirrer shaft in order to create a conveyor effect on the glass melt from the inlet towards the outlet. By way of example, the stirrer paddles are constructed as plate-shaped elements which have paddle areas arranged or set at an angle to the direction of rotation of the stirrer shaft so that the glass melt is transported in a spiral manner along the stirrer shaft towards the outlet. One way to alter the degree of homogenization would be to vary the rotational speed of the revolving stirrer shaft, but this would involve a change in the total throughput and could also lead to a drop in pressure. In order to avoid this, it is particularly proposed that at least two of the stirrer paddles are set opposite each other and accordingly these markedly reduce the conveyor effect from the inlet to the outlet or even reduce it to the extent that it is infinitesimally small.

A stirring device for stirring a glass melt is known from JP 2004 224 637 A. The stirring device or the stirrer is provided with a spiral-shaped screw blade (“stirring blade 12”) arranged on the stirrer shaft. This blade encompasses the stirrer shaft longitudinally and is in the shape of a spiral or screw. In one embodiment disclosed in this reference the stirrer shaft is also provided with several stirrer paddles, which are constructed as paddle-shaped elements (see elements “14” in FIG. 2D) that extend radially from the stirrer shaft. The spiral-shaped stirring blade integral with the paddle-shaped stirrer paddles is arranged on the stirrer shaft so that the paddle-shaped stirrer paddles divide the stirring blade into several sections.

A further stirring device for stirring a glass melt is known from U.S. Pat. No. 2,891,777 A. The stirring device or stirrer has several stirrer paddles which are constructed as paddle-shaped elements (see “19” in FIGS. 3 and 5) and which are arranged at intervals to each other on several levels along the stirrer shaft. The paddle-shaped stirrer paddles are reinforced by built-in elements (“ribs or webs 20”), which extend in each case from the paddle area to the stirrer shaft.

In DE 10 2006 060 972 A1, a device for homogenizing a glass melt is proposed which also has at least one stirring device in which a plurality of stirrer paddles are arranged at intervals to each other on a rotatable stirrer shaft. In particular, this DE reference addresses the following problems: in order that adequate homogenization can be achieved with high viscosities and small chemical diffusion coefficients, a gap of minimum width must be provided between the stirrer paddles and the internal wall of the mixing vessel or melt container. However that involves the risk that the stirrer comes in contact with the vessel wall, thus possibly causing damage to or even destruction of the stirring device. At least high shear stresses between the stirrer paddles and the melt container wall occur, which can impair the lifespan of the stirring system considerably. There is also the danger that bubbles which adhere to the melt container wall are sheared off and end up in the product if the margin gap is too narrow. In order to solve these problems DE 10 2006 060 972 A1 proposes to design the device so that a melt flow produced by the axial conveyor effect seals the gap between wall area and stirrer paddles against the glass melt flowing directly through the gap. This results in the gap being sealed dynamically, so consequently the gap can have a greater gap width. In order to achieve dynamic sealing, the setting angle, the geometric shape and/or the helix-type arrangement of the stirrer paddles are optimized.

The use of the known devices to homogenize a glass melt has shown that bubbles can nevertheless form in the glass melt to a considerable extent. In addition, the known structures have stirrer paddles or stirring elements of larger dimensions, whereby a relatively large quantity of coating material is required for coating them, usually equating to a special noble metal alloy. Accordingly, the known structures are quite expensive to make. Therefore, there is a need to further improve the known devices.

### SUMMARY OF THE INVENTION

The object of the present invention is therefore to provide a device for homogenizing a glass melt which can achieve a high degree of homogenization while simultaneously reducing costs. Moreover, it should be possible to effectively suppress the formation of gas bubbles.

This object is achieved by a device with the features of the claims appended herein below.

According to the invention the device for homogenizing a glass melt has at least one stirring device, in which a plurality of stirrer paddles are arranged on a stirrer shaft and at intervals from each other, at least a majority of the plurality of stirrer paddles being constructed as paddle-shaped elements, each having a front-facing paddle area displacing the glass melt and a back-facing paddle area, and that at least one built-in element is arranged on one of the paddle areas, which extends from the paddle area to the stirrer shaft. This structure is distinguished in that the at least one built-in element has an edge which extends from the stirrer shaft in a radial direction along the paddle area with an edge length which is less by a specified distance than the length of the paddle area extending in the radial direction. Accordingly, the built-in element does not reach to the outer edge or the margin of the stirrer paddle and a specified distance remains in place. The components are thus fully concealed by the stirrer paddle in the direction of rotation. This leads to a further reduction in the reboil tendency.

The invention is based on the finding that paddle-shaped stirrer paddles can have a very narrow design and thus save on material if built-in elements are arranged on them, which extend from each paddle area to the stirrer shaft and thus support and stabilize each stirrer paddle. In this arrangement, the built-in element does not reach to the outer edge or the margin of the stirrer paddle, and a specified distance remains in place. Moreover, during practical tests on the use of such a structure, it was established that the built-in elements also significantly reduce the formation of bubbles, particularly if the built-in elements extend substantially parallel to the direction of rotation of the stirrer shaft. Accordingly, it was recognised that built-in elements that should actually serve to support the stirrer paddles can also effectively solve the aforementioned problem of gas bubble formation. The built-in elements are preferably located behind the stirrer paddles, i.e. that each built-in element is arranged on the back face of the paddle area. In other words: built-in elements are provided on the paddle area of the stirrer paddles that is not exposed to the flow, i.e. on the back face or lee side. As a result, the under-pressure generated on the back face of the stirrer paddle, which is particularly relevant to bubble formation, is moderated and the occurrence of high gradients in pressure distribution is avoided.

Because of the specific distance, i.e. the difference between the length of the built-in element and the length of the paddle, the built-in element is totally covered by the paddle wherein the outer edge of the paddle is not influenced by the built-in element. The effect of the stirrer paddle is not reduced. It was observed that, in fact, the at least one built-in element substantially reduces the occurrence of reboiling and the resulting bubbling. The same applies to the improvement of homogenizing effects. It was found to be advantageous if the distance is determined according to the size of the gap between the paddle and the inner wall of the mixing vessel, wherein the distance may be 0.5 to 2 times (50% to 200%) the size of the gap. Thus the built-in elements or components according to the invention, which are preferably arranged on the side away from the direction of rotation (back-facing paddle area), have the effect of markedly reducing the risk of bubble formation, particularly by reboil occurrence. Moreover, the built-in elements contribute towards stabilizing the stirrer paddles.

Experiments were able to prove that the average occurrence of bubble defects can be significantly reduced by approx. 20 percent. Furthermore, when operating the stirrer, the number of so-called knots was shown to fall markedly at higher rotational speeds (starting from approx. 50 to 60 rpm); rotational speeds of 60 to 100 rpm are optimum. Knots are local areas in the glass melt (similar to striae with a different type of chemical composition) which have a much higher viscosity and are particularly difficult to homogenize.

The paddle-shaped paddles can be bent. In particular the back-facing paddle area can have a convex shape in order to attain greater inherent stability. For this purpose, one or several built-in elements can be provided on each stirrer paddle, the elements having an additional stabilizing and supporting effect and simultaneously also a reducing effect on bubble formation. For example, only one single built-in element can be provided on the respective stirrer paddle, e.g. in the shape of a plate-shaped element. In addition, a group of several elements arranged in parallel (e.g. bar-shaped) can be provided on a stirrer paddle. In addition, the at least one built-in element can have an essentially triangular shape. The components can therefore consist of one or several bodies per paddle, constructed for example as plates, cylinders or bars. They serve to break down bubble formation, particularly reboil, secondary and/or first (new) bubble formation caused by cavitation, but also as a mechanical support to divert tilting moments exercised on the paddles.

The paddle-shaped stirrer paddles are preferably arranged along the stirrer shaft in several steps or levels, each level having at least two stirrer paddles, preferably three, and in each case intermediate spaces are provided between the levels. In this way, a multi-step stirrer is realized, which has no stirrer paddle levels interleaved in each other or overlapping, but which provides sufficient intermediate free space in which the glass melt is not caught by a stirrer paddle. In this way a compact arrangement or interleaving of the stirrer paddles is avoided, which would lead to the entire content of the stirrer, in other words the whole mass of the glass melt to be stirred, revolving more or less as a cylindrical, composite mass (glass billet), which would considerably lessen the desired stirring effect. An intermediate space is preferably dimensioned so that its area projecting perpendicularly to the axis of rotation of the stirrer is at least 5 percent and at maximum 90 percent of the area that is produced by an area image of the stirrer paddles projecting perpendicularly to the axis of rotation of the stirrer (at one level). In this way the homogenization result is further improved. Overall, this results in an arrangement of stirrer paddles that are very clearly broken up by intermediate spaces, the inherent stirrer paddles being capable of very narrow design. In each case, preferably three stirrer paddles are arranged per level, the stirrer paddles capable of having a different setting angle from one level to the next. In addition, the distribution of stirrer paddles (120 degree star pattern) can be offset from one level to the next (an azimuth angle shift of 60 degrees). This measure also markedly increases the homogenization effect of the stirrer.

The sub-claims also relate to this and further advantageous embodiments.

Accordingly, it is it is advantageous if the specified distance, by which the length of the built-in element is shorter than the length of the paddle, is from 10% to 50%, in particular 20% to 30%, of the length of the paddle.

Moreover, it is advantageous if a gap remains between the respective paddle end and the adjoining wall of the mixing vessel, which preferably has a length of 4.5 to 10.5 percent of the diameter of the stirrer. With respect to this gap, the distance should preferably be chosen to have a size of 0.5 to 2 times (50% to 200%) the gap's size.

In addition, the stirrer paddles are dimensioned so that the diameter of the circle described by the rotating stirrer paddles is not less than 1.5 times and not more than 5 times the diameter of the stirrer shaft.

The particularly plate-shaped built-in element can have an edge that extends from the stirrer shaft in a radial direction along the paddle area with an edge length which is less by a specified distance than the length of the paddle area extending in a radial direction. It is advantageous if the stirrer paddles, specifically the front-facing paddle area, have a convex shape, particularly a convexly arched shape in the direction of rotation. The components preferably positioned behind the stirrer paddles are then on the back-facing (concave) paddle area and for example are oriented perpendicular to the chord of the concave paddle area. However, it is also possible to attach the components in other locations and positions.

The device is preferably designed with several steps, i.e. the stirrer paddles are arranged in the axial direction along the stirrer shaft in several steps or levels, reduced stirrer paddles being arranged at least at a first or a last step, which have a smaller surface area than the stirrer paddles arranged in the other steps. Accordingly, the effective area of the stirrer paddles is not identical in all places, but is reduced particularly at the beginning of the stirrer shaft (in the upper zone) and/or at the end (in the lower zone). This is achieved for example by shortening the paddle height and/or paddle width. Shortening the paddles, for example in the inflow area of the glass melt, improves homogenization further.

The setting and inclination of the stirrer paddles can also be different. The stirrer paddles are preferably located in a first (positive) inclination at least in the first two steps (in the upper zone), whereby the glass melt is conveyed towards the outlet. In contrast, the stirrer paddles in at least the last two steps (in the lower zone) are arranged in the reverse (negative) inclination. The stirrer can be constructed as multi-numbered or N-numbered, i.e. provided with N paddles per level. The stirrer is preferably constructed as tri-numbered.

As mentioned above, the device can preferably be constructed so that the stirring device has a gap of specified width between the outer paddle ends, particularly paddle edges, of the stirrer paddles and the inner wall of the mixing vessel.

### BRIEF DESCRIPTION OF THE DRAWINGS

Further features, advantages and objects of the invention are made apparent from the following detailed description of preferred embodiments shown in the accompanying drawings and examples, in which:

FIG. 1 is a schematic perspective view of a stirring device according to a first embodiment of the invention;

FIG. 2 is a side view of the stirrer device assembled in a mixing device according to the invention;

FIG. 3a is a partial view of the stirring device with stirrer shaft and stirrer paddles arranged on it;

FIG. 3b is a representation of the projected areas covered by the stirrer paddles and of the projected areas of the intermediate free spaces of the stirring device of FIG. 3a;

FIG. 3c is a representation showing the azimuthal distribution of stirrer paddles in the stirring device of FIG. 3a;

FIG. 4a is a detailed perspective view of a stirrer paddle with a built-in element arranged on it;

FIG. 4b is a cross-sectional view of the stirrer paddle shown in FIG. 4a showing the arrangement and the dimensioning of the built-in element;

FIG. 5 is a schematic perspective view showing an alternative embodiment for a stirrer paddle with built-in elements; and

FIG. 6 is a schematic perspective view showing another alternative embodiment for a stirrer paddle with somewhat different built-in elements.

### DESCRIPTION OF THE PREFERRED EMBODIMENT

The figures show elements or groups of elements that are identical or that produce essentially similar effects with identical reference numerals.

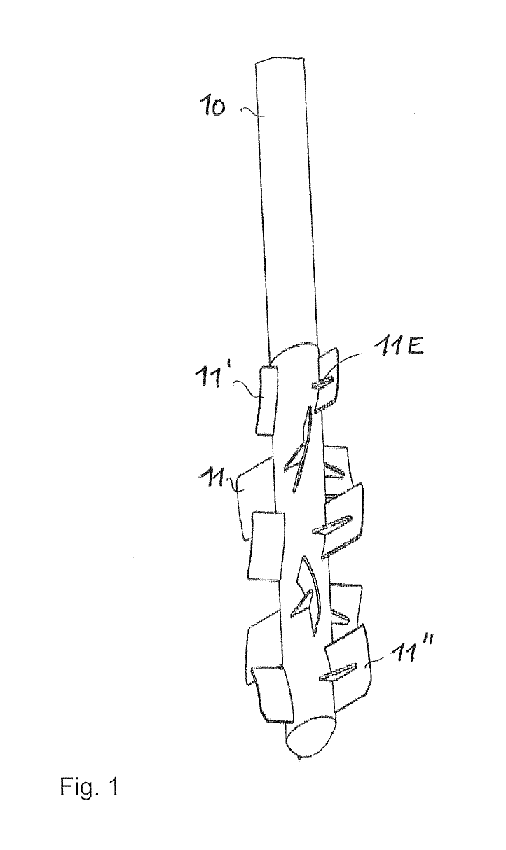

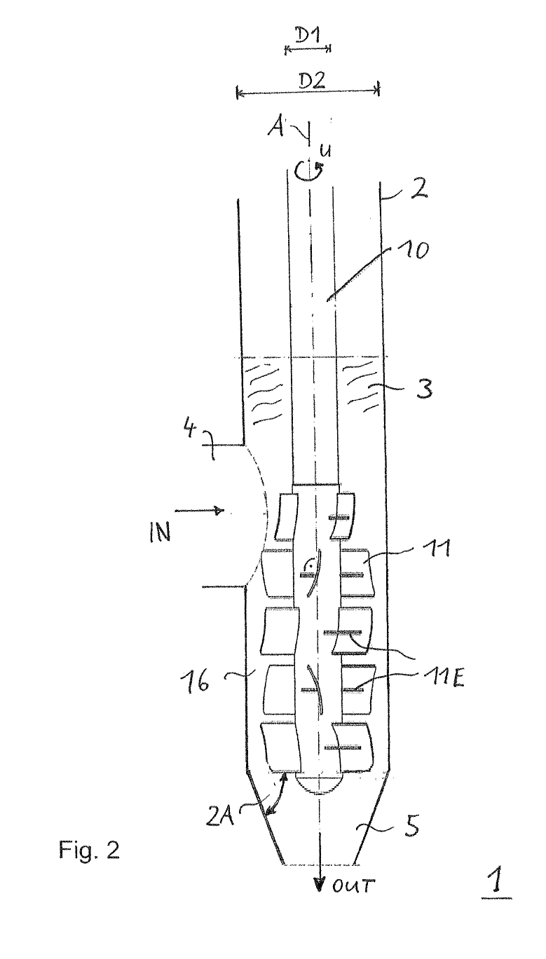

FIG. 1 shows the structure of a stirring device according to the invention, hereinafter also called “stirrer” for short. The stirrer is to be installed in a device for homogenizing a glass melt. The stirrer has a stirrer shaft 10 whose upper end is driven by a motor (not illustrated) in order to rotate the stirrer shaft 10 in a direction of rotation. For example, the normal range of rotational speeds for the stirring entity is between approximately 10 rpm and 100 rpm. At the lower end of the stirrer, paddle-shaped stirrer paddles (hereinafter also called “paddles” for short) are distributed over several levels or steps. The paddles can be of very narrow shape and save on material; they can also be of different sizes. The uppermost level has stirrer paddles 11′ with a slightly reduced surface area. The lowermost row also has stirrer paddles 11″ with a reduced surface area. The lower edges of these paddles 11″ are chamfered in order to accommodate the outlet area of a mixing vessel (see FIG. 2). In the middle levels are stirrer paddles 11 which have a non-reduced surface area, which extend only so far to the inner margin of the mixing vessel and which leave a specific gap. Through the configuration of the shape, arrangement, setting angle of the paddle, etc., the glass melt flow can be influenced so that the gap is dynamically sealed to prevent the glass melt from directly flowing through it.

As can already be seen from FIG. 1, the paddle-shaped stirrer paddles are arch-shaped and each has a built-in element 11E on one of their surfaces. The paddles can be welded onto the shank or shaft 10 of the stirrer. Alternatively or in addition, the paddles can be secured in shank sheaths, inserted through the shank and/or secured in an internal anchorage. In this arrangement the shank sheath can be shrunk onto the shank or stirrer shaft 10 and/or secured by pin or custom fit.

FIG. 2 shows the stirring device of FIG. 1 assembled in a device 1 which has a mixing vessel 2 with e.g. a cylindrical shape. A glass melt 3 is contained in the mixing vessel 2. The glass melt 3 can flow continuously or discontinuously through the mixing vessel 2, from the inlet 4 to the outlet 5. The mixing vessel 2 is preferably arranged in line with gravitational force so that the inlet 4 is located in the upper zone of the stirrer. The front stirrer paddles 11′ when viewed in the flow direction are located in the zone of the inlet 4 and cover part (0-50 percent) of the cross-section of inlet 4. In the example shown here, the inlet, which has a diameter of 120 mm, is covered for a length of 77.5 mm.

The outlet 5 is located in the lower zone of the stirrer and thus at the lower end of the mixing vessel 2, which is constructed with a conically tapering section 2A. The overall conveyor effect of the stirrer 10 is not simply determined by gravitational force, but essentially by the rotational speed of the stirrer and particularly by the arrangement and design of the stirrer paddles secured to it. To simplify the description, reference is made here to the middle stirrer paddles 11 as examples of all stirrer paddles.

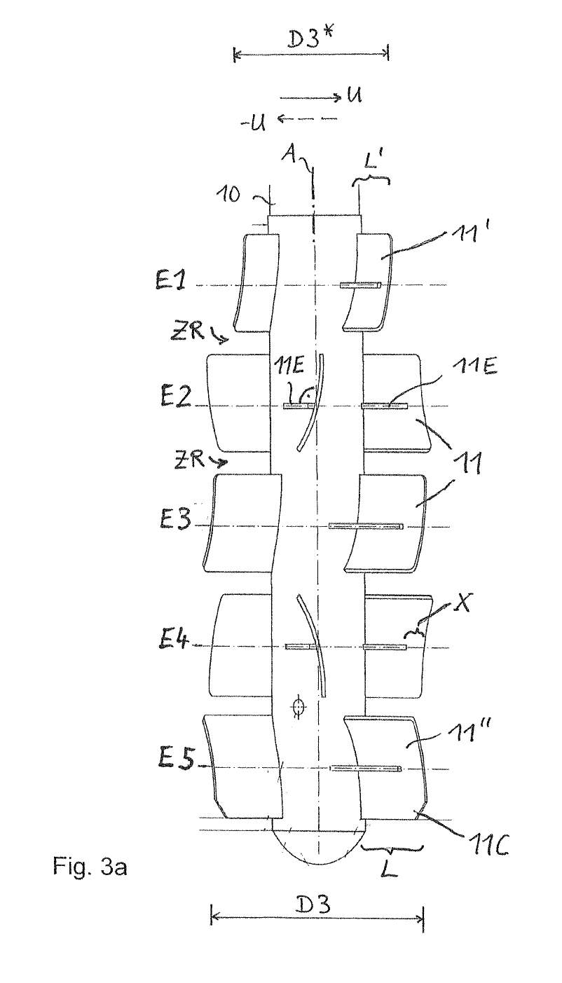

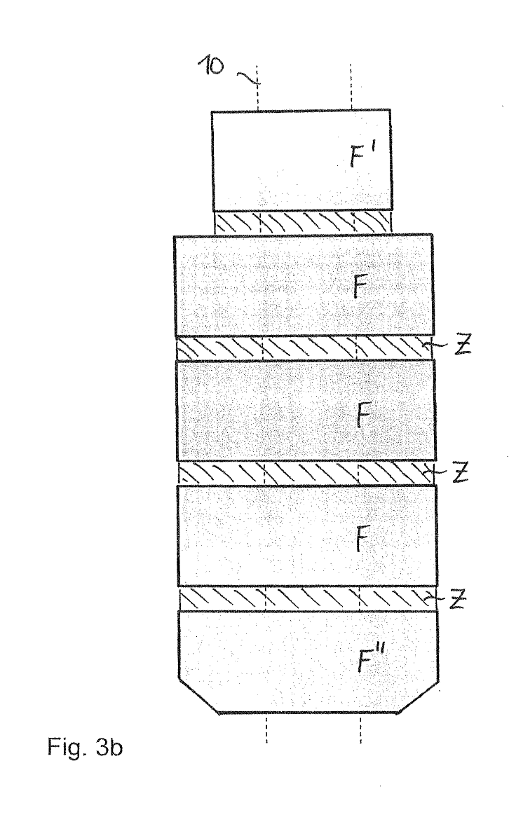

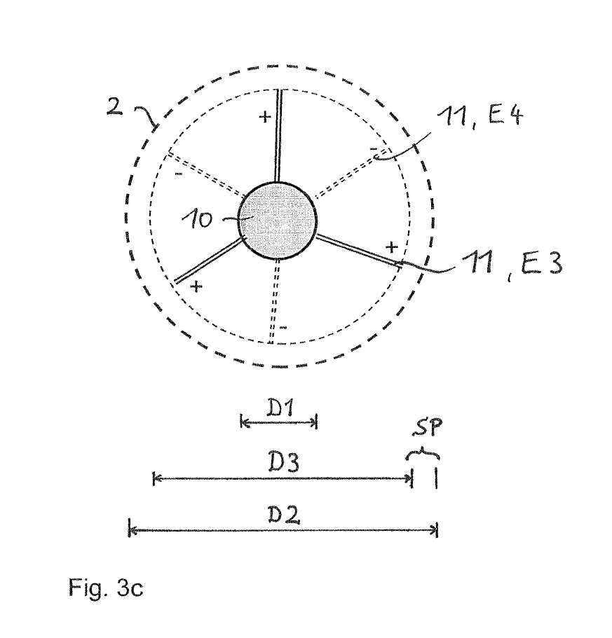

The stirrer paddles 11 shown in FIG. 2 are convexly shaped. I.e. they have a front bulge or a camber, which points in the direction of rotation U of the rotating stirrer 10. In this arrangement the paddles 11 are arranged at an inclination. The paddles 11 extend in a radial direction only so far that a desired gap SP (margin gap or distance) remains between the outer paddle margin and the inner wall of the mixing vessel 2 (FIG. 3c). The gap size and geometrical shape of the stirrer paddles 11 and their setting angle or angle positions enable the flow conditions in the mixing vessel 2 to be precisely adjusted. The design is optimized so that even if the rotational speed of the stirrer varies (between about 10 rpm. to 100 rpm), the flow rate and total glass melt flow through the mixing vessel 2 varies only to a small extent, for example up to a maximum ±5%, preferably up to a maximum ±1%, based on the total flow rate and total glass melt flow through the mixing vessel 2.

The stirrer paddles 11 are each provided with a built-in element 11E which is constructed for example in a plate shape and extends essentially in parallel to the direction of rotation U. The built-in elements 11E can be oriented perpendicularly to the axis of rotation and thus have themselves no significant conveyor effect on the glass melt. It has been shown that a modified orientation of the built-in elements 11E can be tolerated up to a maximum ±45 degrees. In the example shown here, each built-in element 11E is located on the back-facing or rear area of the paddle 11, i.e. on the area which does not point in the direction of rotation U, but which is located on the side not facing the flow. The built-in elements 11 are constructed for example as triangular-shaped plates whose lateral areas are oriented at right angles to the axis of the stirrer shaft 10. Each built-in element 11E extends in a radial direction on the back-facing area of the paddle 11, but does not reach the outer margin of the paddle 11 so that a distance X remains (see also FIG. 3a).

FIG. 3a shows the lower area of the stirrer 10 with the stirrer paddles arranged on it. The paddles are arranged over each other in several, in this instance five, levels or steps E1 to E5. The paddles 11′ of the first or uppermost level E1 and the paddles 11″ of the last or lowermost level E5 are of reduced size compared to the other paddles 11. In addition, the lower paddles 11″ have a notch 11C on their lower edges in order to fit the conical shape of the mixing vessel (see also FIG. 2). The paddles of the three upper levels E1, E2 and E3 are located in a first angled position so that, when the stirrer 10 is rotated, the glass melt is conveyed downwards from these paddles to the outlet. The paddles of the two lower levels E4 and E5 are located in a second reversed angle position so that, when the stirrer 10 is rotated, the glass melt is urged upwards from these paddles and the downwardly directed glass melt is braked.

Free space or paddle-less intermediate spaces ZR are provided between each level, the function of which is described in more detail below in relation to FIG. 3b.

The lower end of the stirrer 10 can be provided with an end piece, e.g. a cap whose radius is preferably greater than double the shank radius, in this instance for example three to five times the shank radius. The stirrer paddles themselves are preferably chamfered perpendicular to their thickness towards all sides at the end or margin. The stirring device can be designed so that the glass inflow (see “IN” in FIG. 2) can be at the side and the glass outflow (see “OUT” in FIG. 2) is in the lower area in the center or also eccentric below the lower paddle level. The mixing part or mixing vessel itself can be polygonal or cylindrical and can also have a cone shape in the lower zone.

FIG. 3b illustrates the structure of a stirrer provided with many free spaces using a representation of the projected areas F covered by the stirrer paddles and of the projected areas Z in the free or intermediate spaces lying in between (see also ZR in FIG. 3a). The area F thus indicates the area that is created by a projection oriented perpendicularly to the axis of rotation of one of the middle stirrer paddle levels (see E2-E4 in FIG. 3a). Accordingly, the area F represents essentially the effective stirring area per level which acts upon the glass melt during rotation. The area F′ or F″ corresponds to projections at level E1 or E5. Intermediate spaces are kept free between the levels (see also ZR in FIG. 3a). In these intermediate spaces there is no displacement or circulation of the glass melt caused by the stirrer paddles. The areas Z in FIG. 3b correspond accordingly to free areas and projections of the free spaces provided in which the glass melt is not directly displaced or moved by the stirrer paddles or other elements moving in the direction of rotation. This quasi dispersed construction style prevents the glass melt located in the mixing vessel from rotating as a whole with the rotating stirrer and thus impeding a gradual circulation of the glass melt. For this reason, very thorough mixing and homogenization of the glass melt can be achieved. The ratio Z:F more or less gives the ratio of the free stirrer zones to the effective stirrer zones. It has been shown that Z should not be less than 5 percent and not more than 90 percent of F in order to achieve a high homogenization effect.

FIG. 3c shows a cross-sectional view of the representation in FIGS. 3a and 3b perpendicular to the axis of rotation and illustrates the azimuthal arrangement and distribution of stirrer paddles and their dimensioning in relation to the diameter of the stirrer shaft and/or mixing vessel. Here the stirrer is constructed for example with three rows in each of which three paddles or paddles 11 are arranged symmetrically in a star shape in each level (see also E1-E5 in FIG. 3a). This produces an angle (azimuth) of 120 degrees between two adjacent paddles. The arrangement of the paddles alters from one level to the next with each of the paddles being turned by 60 degrees or being offset. Furthermore, the setting (angle in relation to direction of rotation) of the paddles can also be altered from level to level. The upper paddles preferably have a positive setting angle at levels E1 to E3, i.e. an orientation that causes the glass melt to be displaced downwards to the outlet. In contrast, the lower paddles at levels E4 and E5 have a negative angle position which would cause the glass melt to be conveyed upwards and thus brake the downward conveyance. Overall, this sets in motion an almost neutral mass flow rate in the stirrer so that the glass melt moves only very slowly (more or less only under the influence of gravitational force) downwards to the outlet. The stirrer can thereby be optimized so that conveying neutrality prevails as far as possible.

FIG. 3c also illustrates the dimensioning of the stirrer. It has been shown that, in relation to the diameter D2 of the mixing vessel 2, the diameter D1 of the stirrer shaft 10 should preferably meet the following dimensioning rule: D1 should be approximately 25 to 50 percent of D2. Furthermore, the following should apply: D1=[0.25 to 0.6]×D3, D3 being the diameter of the normal stirrer paddle level (see e.g. E3 in FIG. 3a). Accordingly, a margin gap SP between paddle ends and inner wall of the mixing vessel 2 should remain as follows: SP=[4.5 to 10.5]D2/100, that is the margin gap should be approximately 4.5 to 10.5 percent of the diameter D2.

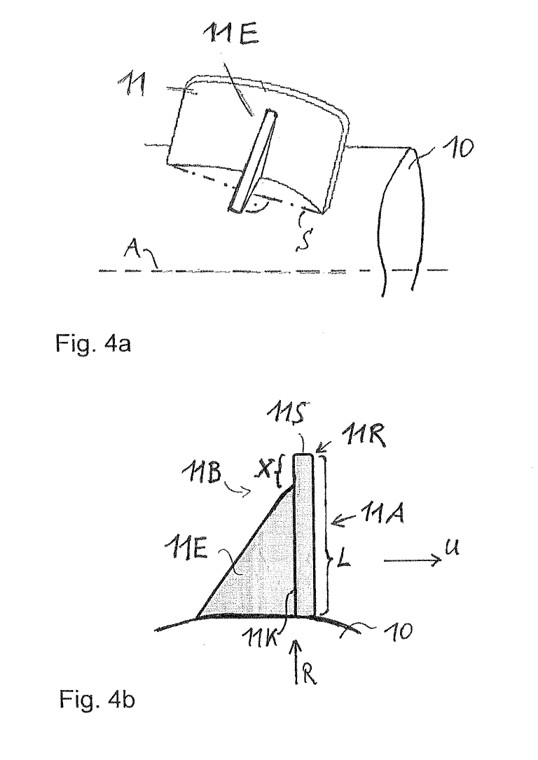

FIGS. 4a and 4b illustrate in detail the embodiment of a paddle-shaped stirrer paddle 11 and a built-in element 11E arranged on it. The paddle 11 is arch-shaped and has a convex first area 11A (front face of the paddle) which points in the direction of rotation U of the rotating stirrer and a second concave area 11B (back face of the paddle) which points in the opposite direction. In this way, when the stirrer is rotated, the glass melt flows towards the area 11A (see also FIG. 2). A built-in element 11E is provided on the second area 11B which is not facing the flow, which is essentially a triangular platelet and is aligned so that the lateral areas of the platelet are oriented perpendicularly to the chord S (circle chord) of the arch-shaped paddle. Thus the orientation of the built-in element 11E is adapted to the orientation of the paddle 11. Moreover, all built-in elements (also see FIG. 6) are totally covered by the paddle and therefore the paddle effect is not reduced. The built-in elements extend perpendicularly away from the axis of rotation of the stirrer 10, i.e. they extend in the radial direction R, the platelet remaining neutral to the direction of rotation of the stirrer 10. The built-in element 11E or platelet has an edge 11K which runs in a radial direction R along the back-facing area 11B, indeed so far that it does not project to the margin zone 11C of the paddle 11 but keeps a minimum distance X. The distance X has the size of about 0.5 to 2 times (50% to 200%) of the gap SP (see FIG. 3c). Besides the distance should have about 10% to 50% of the length L of the platelet, preferably 20% to 30% thereof as in FIG. 4b). Such a dimensioning effectively reduces the hydraulic conditions and the bubbling.

As particularly FIG. 4b shows, the paddle 11 is configured very flat and has a thickness of a few millimetres. In addition, the margin areas of the paddle 11 have chamfered edges 11R. The same applies for all edges of the paddle and of the built-in elements. This avoids occurrence of points of inertial cavitation, which can lead to bubble formation. In particular, the margin area 11S facing the inner wall of the mixing vessel has the smallest possible dimensions so that it offers only a very small front area for potential electrical current densities occurring in the glass melt. This is advantageous in stirrers that are heated by current fed to the mixing vessel and where leak currents can occur which flow to and from via the glass melt and therefore these facing areas 11S. It has been shown that particularly with heating by low-frequency A.C. current of e.g. 50 Hz to several kHz, such leak currents (by-pass effect) can occur and result in the formation of gas bubbles. This phenomenon is effectively suppressed by making the front face 11S as small an area as possible.

As described above, the invention provides a device for homogenizing a glass melt in which at least a majority of stirrer paddles, that is more than 50 percent, are constructed as paddle-shaped elements or paddles 11. Each paddle has a front-facing paddle area 11A which displaces the glass melt 3 and a rear paddle area 11B. At least on one of these paddle areas, preferably on the rear paddle area 11B, at least one built-in element 11E is arranged, which extends from this paddle area 11B towards the stirrer shaft 10 (see e.g. FIG. 3a).

The paddle-shaped stirrer paddles 11 are preferably arranged in the axial direction A along the stirrer shaft 10 on several levels E1, E2, . . . , E5, an intermediate space ZR being kept free between two adjacent levels, into which space none of the stirrer paddles 11 projects (see FIGS. 3a and 3b). The levels E1, E2, . . . , E5 are preferably arranged in the axial direction equidistant to each other. The intermediate spaces ZR are dimensioned so that each intermediate space ZR covers an area Z projecting perpendicularly to the axis of rotation A, which is at least 5 percent and at maximum 90 percent of the projected area F, which covers the stirrer paddles 11 of a level (e.g. level E3) and the associated sub-sector of the stirrer shaft 10 (see FIG. 3b).

The device is constructed so that on each level E1 to E5 preferably three stirrer paddles 11 are arranged, preferably arranged radial-symmetrically. For this purpose, the arrangement can be configured so that the stirrer paddles 11 on one level (e.g. E3) are arranged azimuthally offset in relation to the stirrer paddles of the neighbouring level (e.g. E4), particularly arranged radial-symmetrically and azimuthally offset (see FIG. 3c).

The stirring device has a gap SP between the outer paddle ends or paddle edges 11S of the stirrer paddles and the inner wall of the mixing vessel. The gap or margin gap SP measures, for example, at least 4.5 percent and at maximum 10.5 percent of the diameter D2 of the mixing vessel 2 (see FIG. 3c).

As shown in FIGS. 4a and 4b, the outer paddle ends or paddle edges of the stirrer paddles 11, such as the edges of the front face 11S, are constructed as chamfered margin zones 11R. The paddle-shaped stirrer paddles 11 are constructed as flat elements, the margin zones having a small thickness. In particular, the margin zone 11S (front face) has a thickness of at maximum 5 mm. Thanks to the arch and/or built-in elements, the narrow paddles 11 provide a stable structure, which requires little material, particularly little noble metal (for coating the paddles). In addition, the narrow paddles can prevent interfering leak currents from occurring in an electrically heated stirrer, which flow from the inner wall through the glass melt to the paddle ends and then flowing off in the by-pass through the stirrer shaft. These leak currents would cause bubble formation, particularly if heating is by an A.C. current which has a relatively low frequency below a few kilohertz, e.g. 50 Hz.

As far as the dimensioning of the stirrer shaft is concerned, this has a diameter D1 which is at least 25 percent and at maximum 50 percent of the diameter D2 of the mixing vessel 2 (see FIG. 3c). The stirrer shaft can also have a hollow structure and optionally be filled with gas. In addition, the stirrer shaft can be fabricated from a different material or from a different alloy than the paddles.

The stirring device described here can for example be located directly upstream of a glass feeder (not shown) out of which the emerging glass melt emerges onto the external perimeter of a rotating Danner blowpipe in order to form a closed glass melt casing which after drawing off leads to a glass pipe with an essentially constant external diameter and constant wall thickness. The glass feeder is arranged directly after the outlet 5 of the stirring device (see FIG. 2), that means without interposition of buffering intermediate receptacles. This requires a very constant flow rate from the mixing vessel 2 which can be achieved according to the invention due to the setting angle, geometrical shape and/or angle positions of the stirrer paddles 11 in the circumferential direction of the stirrer shaft 10. The glass melt can for example enter the inlet 4 through a connecting sidepiece extending vertically upwards so that external hydrostatic pressure acts upon the mixing vessel 2 overall in order to push the glass melt to the outlet 5. As will be self-explanatory to the person skilled in the art, the principle underlying the present invention for homogenizing a glass melt can also be used in the manufacture of display glass, particularly glass sheets for LCD, OLED or plasma displays, for the manufacture of glass ceramics, borosilicate glassware, optical glasses or glassware manufactured from glass tubing.

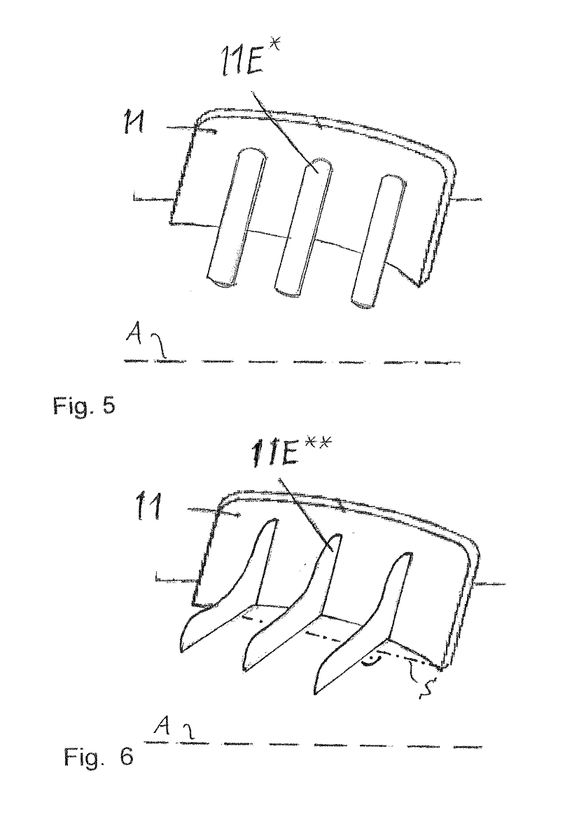

FIG. 5 shows an alternative embodiment of the built-in elements, namely such that several built-in elements are arranged on one stirrer paddle 11, in this instance for example three bar-shaped built-in elements 11E′ each on one stirrer paddle 11. FIG. 6 shows a further alternative embodiment of built-in elements, namely such that a rectangular, flat built-in element 11E″ is arranged on the respective stirrer paddle 11.

The built-in elements according to the invention cause in particular a marked reduction in reboil occurrence and the associated bubble formation (approximately 20% less bubble occurrence). Moreover, the built-in elements also contribute to the mechanical stabilization of the stirrer paddles. The different stirrer paddle levels convey downwards or upwards, so that the flow rate is virtually neutral during operation.

In summary and with reference to the figures described above, a device for homogenizing a glass melt and use of the same is proposed. For this purpose, at least one stirring device is provided, which has a stirrer shaft 10 rotatable in the direction of rotation U and a plurality of stirrer paddles 11, 11′, 11″. The stirrer paddles are arranged at intervals to each other along the stirrer shaft in order to generate an essentially axially aligned conveying effect on the glass melt towards an outlet. To improve homogenization while simultaneously saving on noble metal material, the stirrer paddles 11, 11′, 11″ are constructed as a paddle shape and provided with built-in elements 11E. Each built-in element 11E has an edge 11K which extends from the stirrer shaft 10 in a radial direction R along the paddle area 11B with an edge length which is less by a specified distance X than the length L of the paddle area 11B extending in the radial direction R. These also cause a marked reduction in bubble formation and are preferably arranged in each case behind the paddle area 11B not facing the flow. In addition, the stirrer paddles 11 are arranged on several levels E1-E5, between which free intermediate spaces ZR are provided.

### PARTS LIST WITH DRAWING REFERENCE CHARACTERS

1 Device for homogenizing a glass melt
2 Mixing vessel/melt container
2A Conically tapering section (in lower area of the mixing vessel)
3 Glass melt
4 Inlet (IN)
5 Outlet (OUT)
10 Stirrer shaft
A Axial direction or axis of rotation
R Radial direction
U Direction of rotation of stirrer shaft
11 Stirrer paddles, paddle-shaped (paddle)
11′, 11″ Stirrer paddles in reduced sizes
E1-E5 Levels or steps of arranged stirrer paddles
ZR Intermediate spaces
F, F′, F″ Projected areas of stirrer paddle levels E1-E5
Z Projected areas of free intermediate spaces ZR
+/− First (positive conveying) or second (negative conveying) inclination of stirrer paddles
11A Front (facing flow) area of stirrer paddle
11B Rear (not facing flow) area of stirrer paddle
11C Shortened margin section on lower stirrer paddles
11S Outer margin zone of stirrer paddle
11R Chamfered edge areas
11E Built-in elements on the stirrer paddles
11E*,11E** Alternative embodiments of built-in elements (rod or plate)
11K Edge length of the built-in element (connecting area to stirrer paddle)
X distance to margin zone of stirrer paddle
SP gap/margin gap (in the zone of the inner walling)
D1 diameter of stirrer shaft
D2 inner diameter of the mixing vessel
D3, D3′ diameter of the respective stirrer paddle level

While the invention has been illustrated and described as embodied in a device for homogenizing a glass melt and a method of homogenizing the glass melt using the same device, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

What is claimed is:

1. A device for homogenizing a glass melt (3), said device comprising
a mixing vessel (2) for containing said glass melt (3); and
at least one stirring device (1), which is arranged in said mixing vessel (2) for said glass melt (3), said mixing vessel having an inlet (4) and an outlet (5);
wherein said at least one stirring device (1) comprises a stirrer shaft (10) rotatable in a direction of rotation (U) and a plurality of stirrer paddles (11) arranged at intervals from each other along the stirrer shaft (10), at least a majority of the plurality of stirrer paddles (11) being constructed as paddle-shaped elements, which each have a front-facing paddle area (11A) for displacing the glass melt, a rear-facing paddle area (11B) and at least one built-in element (11E) extending from the rear-facing paddle area (11B), said built-in element (11E) extending from the rear-facing paddle area (11B) to the stirrer shaft (10);
wherein said at least one built-in element (11E) has an edge (11K) which extends from the stirrer shaft (10) in a radial direction (R) along the rear-facing paddle area (11B) with an edge length which is less by a specified distance (X) than a length (L) of the rear-facing paddle area (11B) in the radial direction (R).

2. The device according to claim 1, wherein said specified distance (X) is 10 percent to 50 percent of the length (L) of the rear-facing paddle area (11B).

3. The device according to claim 1, wherein said specified distance (X) is 20 percent to 30 percent of the length (L) of the rear-facing paddle area (11B).

4. The device according to claim 1, wherein the stirring device (1) has a gap (SP) between outer paddle ends of the stirrer paddles (11) and an inner wall of said mixing vessel (2).

5. The device according to claim 4, wherein said gap (SP) has a size that is at least 4.5 percent and at most 10.5 percent of an inner diameter (D2) of the mixing vessel (2).

6. The device according to claim 5, wherein said specified distance (X) is 0.5 to 2 times said size of said gap between said outer paddle ends of said stirrer paddles (11) and said inner wall of said mixing vessel.

7. The device according to claim 1, wherein said stirrer paddles (11) are arranged in an axial direction (A) along the stirrer shaft (10) at respective levels (E1, E2, . . . , E5) and with intermediate spaces (ZR) between said respective levels, which are kept free of a reach of said stirrer paddles (11).

8. The device according to claim 7, wherein said respective levels (E1, E2, . . . , E5) are arranged equidistant from each other in said axial direction.

9. The device according to claim 7, wherein each of said intermediate spaces (ZR) covers an area (Z) projected perpendicular to an axis of rotation (A) of the stirrer shaft (10) and said area (Z) covered by said intermediate spaces (ZR) corresponds to at least 5 percent and at most 90 percent of a projected area (F) that is covered by one of said stirrer paddles (11) at one of said respective levels and an associated sub-sector of the stirrer shaft (10).

10. The device according to claim 7, wherein at least two of said stirrer paddles (11) are arranged at each of said respective levels (E1, E2, . . . , E5).

11. The device according to claim 10, wherein said at least two of said stirrer paddles arranged at each of said respective levels are arranged in a radially symmetrical relationship to each other.

12. The device according to claim 10, wherein said at least two of said stirrer paddles consist of three of said stirrer paddles.

13. The device according to claim 7, wherein said stirrer paddles (11) arranged at one of said respective levels (E4) are arranged azimuthally offset in relation to said stirrer paddles (11) at another adjacent one of said respective levels (E3).

14. The device according to claim 13, wherein said stirrer paddles arranged at said one of said respective levels (E4) are also arranged radially symmetrically offset as well as azimuthally offset in relation to said stirrer paddles at said another adjacent one of said respective levels (E3).

15. The device according to claim 7, wherein said stirrer paddles (11′, 11″) arranged at least at a first one and/or a last one of said respective levels (E1; E5) have a smaller surface area than that of said stirrer paddles (11) arranged at remaining ones of said respective levels (E2-E4).

16. The device according to claim 7, wherein at least at a first two of said respective levels (E1, E2) the stirrer paddles (11) are arranged in a first inclined position (+) to an axis of rotation (A) of the stirrer shaft (10) and the stirrer paddles (11) are arranged in an inclined position reversed thereto at least at a last two of said respective levels (E4, E5), said first inclined position (+) causing a conveying displacement of the glass melt (3) towards the outlet (5) of the mixing vessel (2).

17. The device according to claim 1, wherein said at least one built-in element (11E) arranged on each of said stirrer paddles (11) is arranged on said rear-facing paddle area (11B).

18. The device according to claim 1, wherein said at least one built-in element (11E) arranged on each of said stirrer paddles (11) corresponds to a single plate-shaped element (11E; 11E**) or to a group of several bar-shaped elements (11E*) arranged in parallel.

19. The device according to claim 1, wherein said at least one built-in element (11E, 11E**) has an essentially triangular shape.

20. The device according to claim 1, wherein said front-facing paddle area (11A) has a convex arched shape in said direction of rotation (U).

21. The device according to claim 1, wherein the stirrer paddles have outer paddle ends or outer paddle edges that have chamfered margin zones (11R).

22. The device according to claim 1, wherein said stirrer paddles (11) are designed as flat elements which have margin zones (11S) in line with an inner wall of the mixing vessel (2), each of said margin zones (11S) having a thickness of at maximum 5 mm.

23. The device according to claim 1, wherein the stirrer shaft (10) has a diameter (D1) that is at least 25 percent and at maximum 50 percent of a diameter (D2) of said mixing vessel (2).

24. A stirring device (1) for a device for homogenizing a glass melt, said stirring device being arrangeable in a mixing vessel (2) that contains the glass melt, said mixing vessel having an inlet (4) and an outlet (5), said stirring device comprising a stirrer shaft (10) rotatable in a direction of rotation (U) and a plurality of stirrer paddles (11) arranged at intervals from each other along the stirrer shaft (10), at least a majority of the plurality of stirrer paddles (11) being constructed as paddle-shaped elements, which each have a front-facing paddle area (11A) for displacing the glass melt, a rear-facing paddle area (11B) and at least one built-in element (11E) extending from the rear-facing paddle area (11B), said built-in element (11E) extending from the rear-facing paddle area (11B) to the stirrer shaft (10);
wherein said at least one built-in element (11E) has an edge (11K) which extends from the stirrer shaft (10) in a radial direction (R) along the rear-facing paddle area (11B) with an edge length which is less by a specified distance (X) than a length (L) of the rear-facing paddle area (11B) in the radial direction (R).
